(19) United States
(12) Patent Application Publication
(10) Pub. No.: US 2026/0281285 A1
(43) Pub. Date: Sep. 17, 2026

(54) Projection Unit on Board a Vehicle, Vehicle and Method

(71) Applicant: Bayerische Motoren Werke Aktiengesellschaft, Muenchen (DE)

(72) Inventors: Joern HOFHAUS, Freising (DE); Robert ISELE, Fuerstenfeldbruck (DE); Michael MUELLER, Muenchen (DE); Carina SOUKOP, Essenbach (Mirskofen) (DE)

(21) Appl. No.: 18/877,786

(22) PCT Filed: Jun. 30, 2023
(86) PCT No.: PCT/EP2023/068068

§ 371 Date: Dec. 20, 2024

(30) Foreign Application Priority Data
Jul. 21, 2022 (DE) 10 2022 118 315.7

(51) Int. Cl. H04N 9/31

(52) U.S. Cl. CPC H04N 9/3147

(57) ABSTRACT

A projection unit on board a vehicle includes a projection module with which a first visual representation can be generated via projection onto a surface in a vehicle interior. The projection unit is designed to generate and/or coordinate a combined total representation, in which the first visual representation is projected onto the surface in the vehicle interior, and another second visual representation is reproduced elsewhere in the vehicle interior. The projection unit and/or the projection module have a coordination interface via which a coordination signal relating to the first and/or the second visual representation is transmitted between the projection unit and the vehicle.

### BACKGROUND AND SUMMARY

The invention relates to a projection device on board a vehicle and a vehicle and a method for generating and/or coordinating a visual overall representation on board a vehicle.

On board a vehicle or motor vehicle, in addition to operating elements or control elements such as the steering wheel, rear view mirror or control displays, which can be positioned in or above the instrument panel, a display device is also often provided in the form of a display. Such a display device or display can not only serve as a navigation device, but can also be used to play back a video for entertainment purposes.

A visual representation in the form of a video can be played back, for example, in traffic jams or during breaks in driving. For example, the display may be positioned in a position observable by the driver and/or passenger in the front section of the passenger compartment; approximately in the middle of the front interior trim between the driver's instrument panel and the glove compartment of the front passenger or below it, for example in, on or above the center console.

For entertainment purposes, other visual effects can also be used on board a vehicle. For example, an illumination device that produces the interior lighting in the vehicle and contains, for example, a number of illumination sources or light sources located in the vehicle roof and/or elsewhere in the passenger compartment, can also be used to create an atmospheric ambience in the interior and, if appropriate, also to vary this time-dependently; a temporal variation of the illumination can also be used for entertainment purposes.

However, apart from interior illumination in the vehicle and/or reproduction of videos by means of a display in the vehicle, it is also contemplated to use a visual projection in the passenger compartment to radiate to or to illuminate this inner space, a part of the interior trim thereof or at least a certain surface in the interior. Such a projection could be realized for example, by means of a projection module that projects a separate image consisting of a large number of pixels onto the surface in the interior space. In addition, it would be contemplated to use the projection module to project a video or at least a time-dependent sequence of images onto the surface in the interior. For example, the instrument panel, the glove compartment or an observable surface in front of the driver and/or passenger could be used to project and thus reproduce images, sequences of images or videos; for example, a surface area that is located in front of the driver or front passenger where the instrument panel or glove compartment or a surface area above this is conventionally arranged. In particular, a surface of the interior trim in front of the driver or front passenger, located below the windscreen or front screen, would be usable for such a projection for entertainment or accompaniment purposes; for example to visually accompany a video played back on the display. But a surface projection in the interior of the vehicle could also be used as an independent visual means of entertainment; for example, by projecting it onto the back of the backrest and/or headrests of the front seats to entertain passengers in the rear seats.

Although such surfaces in the interior that can be observed from the front or rear seats do not have a comparably high visual reproduction quality as the display surface of a display or display device, they are in principle sufficiently suitable to create or supplement an atmospheric ambience.

In order to create a (first) visual effect that is projected onto one or more surfaces in the vehicle, a suitable projection module had to be housed in the vehicle. Thus, mutually independent, different types of systems with which a visual effect can be generated, in particular for entertainment purposes, are contemplated in a vehicle.

If a visual effect is to be projected onto a surface in the vehicle, a suitable projection module would have to be provided in the vehicle; this would be an independent visual means that enables visual styling of selected surfaces in the passenger compartment.

The object of the present invention is to expand the possibilities of visual design in the passenger compartment and without considerable additional equipment to realize a more intense, catchy and/or immersive visual experience for the vehicle occupants than is possible with previously available visual aids in the vehicle.

This object is achieved by the subject matter of the independent claims. The dependent claims reflect some of the preferred embodiments.

According to the invention, a projection device on board a vehicle containing a projection module capable of producing a first visual representation by projecting it onto a surface in a passenger compartment is proposed. The projection device is set up according to the invention to create and/or coordinate a combined overall representation, with which
the first visual representation is projected onto the surface in the passenger compartment, and
elsewhere in the passenger compartment, a different, second visual representation is reproduced,
   wherein the projection device and/or the projection module contains a coordination interface by means of which a coordination signal relating to the first and/or second visual representation is passed between the projection device and the vehicle.

This is the first time that a projection device for operation on board a vehicle is proposed which combines different types of visual systems, intended for different visual effects, used for different purposes and/or based on different visual generation mechanisms, in order to enable the generation of an overall representation or overall performance in which multiple different visual effects interact and/or atmospherically reinforce each other. In particular, a projection device is provided that is able to communicate on board a vehicle with a reproduction device for another, second visual representation; for example with a display or with a device for time-variable interior illumination in the vehicle.

Preferably, it can be provided that the coordination interface contains an output interface which passes control commands generated by the projection device for starting, pausing, resuming and/or stopping the other, second visual representation. As a result, the reproduction device for the other, second visual representation can be controlled in such a way that the other, second visual representation is presented in a temporally coordinated manner with the first visual representation and the two individual representations merge into an overall representation that enables a more immersive visual experience. The temporal coordination of the two individual representations, in addition to time-synchronized playing, can also include periodic or otherwise time-dependent reproductions of the first and/or second visual representations; for example, in the manner of a rhythmic amplification or visual emphasis of one of the two representations by the other. However, other more complicated time-dependent correlations between the two visual representations can also be included.

Preferably, it may be provided that the coordination interface includes an input interface which receives control commands for the projection device to start, pause, resume and/or stop the first visual interface representation. Here a signal available on board the vehicle, in particular in the on-board electrical system, can be used to play back or project the first visual representation as described above temporally coordinated with the second visual representation; here the projection module follows another reproduction device and/or another unit in the vehicle with regard to one or more time constraints.

Preferably, it may be provided that the projection device, the projection module and/or the coordination interface contains a data interface via which video data and/or image data intended for the first visual representation can be transmitted directly to and/or can be stored in the projection device while avoiding and/or bypassing an on-board electrical system installed in the vehicle. A projection device preferably developed in this way would make it possible to supply the projection module with any image material for the video data and/or image data of the first visual representation at any time and especially after installation and commissioning. As a result, the projection device or the projection module would not be limited to data content initially stored before commissioning, which predefined one or more visual effects, but could retrieve any visual effects that were available on the Internet or in the cloud, on a server of the vehicle manufacturer or supplier of the projection device or anywhere else or that possibly can be retrieved after authorization, and could project them in the vehicle. Insofar as the type and/or content of the first visual effect is subject to any restrictions depending on the vehicle model, the geometry of the interior trim and/or depending on the type or frequency of equipment maintenance or workshop visits, such restrictions would be lifted by this developed design.

Furthermore, the image data interface could be designed with higher bandwidth than the coordination interface in order to reduce the load on the coordination interface and to enable coordination with a reproduction device or other unit for the other, second visual representation, which only or mainly uses signals that are already used and exchanged in an on-board electrical system of the vehicle, such as a LIN bus and/or a CAN bus.

Preferably, it can be provided that the image data interface is a wireless interface; for example, a WLAN or Bluetooth interface or another wireless interface.

Preferably, it can be provided that the projection module coordinates the projection of the first visual representation with the playback of a video on a display on board the vehicle and/or the realization of temporal illumination profile of the interior illumination of the vehicle as the second visual representation. Thus, for example, the effect of a video played back on a display or the effect of a temporal variation of interior illumination can be accompanied and reinforced by means of the first visual representation.

Preferably, the projection module can be set up to project image material of video data and/or image data for the first visual representation within an image field of the projection module geometrically pre-distorted according to a defined pre-distortion,
wherein the defined pre-distortion compensates in advance for distortion that occurs when projecting onto the surface in the passenger compartment
due to the arrangement of the projection module decentrally, laterally, obliquely, tilted and/or otherwise relative to the surface and/or the surface normal thereof,
due to a curvature of the surface and/or
due to projecting via a projection mirror.

As a result, the visual material of the first visual representation or the projection can be projected from anywhere in the vehicle; regardless of the direction in which the target surface, i.e. the surface acting as the projection surface or the surface normal thereof points. This may open up additional freedom in the choice of the position in which one or more projection modules of the projection device can be accommodated in the vehicle.

Preferably, the projection device may also preferably contain:
a pre-distortion memory for storing and/or retrieving at least one defined pre-distortion, which compensates in advance for a distortion arising when projecting onto the surface in the passenger compartment, and
an image data memory in which image data of video data and/or image data for the first visual representation are stored or can be stored interchangeably.

The defined or definable pre-distortion defines within a usable image area of the optical imaging system a smaller usable sub-area in which the image material of the video data and/or image data of the first visual representation is pre-distorted or converted. When projecting, only this usable, asymmetrical sub-area of the image area of the projection module projects this image material in a geometrically distorted form, and the size, contour and/or the shape of this usable sub-area is designed in such a way that the surface that is used as the target surface reproduces the image material of the first visual representation in an undistorted manner.

Furthermore, it may be provided that the image data memory stores the respective image material without the defined pre-distortion and that the projection module contains a pre-distortion unit that pre-distorts the image data stored without the pre-distortion according to the defined pre-distortion only when the first visual representation is projected. This means that image data coming from any app or any other source can be accepted and stored without pre-processing, in order to be projected onto the surface in the vehicle.

Alternatively, it may be provided that the projection module contains a pre-distortion unit that pre-distorts the image material for the first visual representation according to the defined pre-distortion before it is first stored in the projection module, and that when the first visual representation is projected, the already pre-distorted image material is retrieved and projected. Here the computational effort for geometrically pre-distorting the image material can be brought forward in time and decoupled from the time or period of the actual playback or projection of the first visual representation; the reduced computational effort during projection reduces the susceptibility to error of the projection.

Furthermore, it may be envisaged that the image data memory contains
a first image data memory in which image data for the first visual representation are accepted and stored when storing without the defined pre-distortion, and
a second image data memory in which the image data taken from the first image data memory and subsequently pre-distorted by means of the pre-distortion unit are stored for later projection of the first visual representation.

This makes it possible to combine the advantages of the time-saving acquisition of image material by the projection module, which is initially carried out without carrying out the pre-distortion, and the projection of the first visual representation, which also saves time and/or computational effort, in that the pre-distortion is carried out at a time or in a period of time sometime after acquisition of the image material but before the projection.

In all embodiments of these applications in connection with which pre-distortion is mentioned, one or more pre-distortions may be included that compensate in advance for a distortion that occurs during projection onto the surface of the passenger compartment
due to the arrangement of the projection module decentrally, laterally, obliquely, tilted and/or otherwise relative to the surface and/or the surface normal thereof,
due to a curvature of the surface and/or
due to projecting via a projection mirror.

This means that the image material of the first visual representation can also
be projected onto curved or singly, dually or multi-curved surfaces in the vehicle,
be projected onto the surface from any position of the projection module relative to the surface and/or
a projection onto the surface can be realized via a flat or curved mirror, without the projected image material, as it is perceived on the surface, appearing in an unrealistic geometric distortion. From an originally rectangular image area or a merely symmetrical and/or trapezoidal sub-area of the image area, an asymmetrically curved, warped sub-area according to the pre-distortion is used for projection; the remaining surrounding area of the projection module remains unused.

Preferably, it may be provided that the projection module is located or installed in an instrument panel or other front structure of the passenger compartment, on a rear view mirror in the passenger compartment and/or on or behind a vehicle display intended for video playback. From its respective position, the projection module can be directed either directly at the surface or at a projection mirror to the surface.

Preferably, it may be envisaged that the projection module projects the first visual representation.
onto the surface of an instrument panel,
onto the surface of an interior trim,
onto any other surrounding projection surface outside and/or near a vehicle display, and/or
onto the surface of any other equipment of the passenger compartment
   and coordinated with a video played back on a display and/or interior illumination varied time-dependently.

It may also be provided that the projection module will display the first visual representation as the main visual motif on the surface of a vehicle seat, backrest, headrest, instrument panel, interior trim, etc. and/or other equipment of the passenger compartment and coordinated with time-dependently varying interior illumination.

In the embodiments of this application, the projection device or the projection module can optionally contain
a DLP (Digital Light Processing) projector with a DMD (Digital Micromirror Device) chip,
an image projection chip made of LEDs or laser diodes, or
a laser scanner.

The object underlying the invention is further achieved by a vehicle containing the described projection device.

The object underlying the invention is further achieved by the method claimed for generating and/or coordinating an overall visual representation on board a vehicle.

To the extent that one or more units in an embodiment—whether designated by a reference sign or not—contains a processing device for the purpose of data processing, wherein this processing device may be set up to carry out, in whole or in part, a method described herein. For this purpose, the processing device may contain a programmable microcomputer or microcontroller and the method may be in the form of a computer program product containing program code means. The computer program product can also be stored on a computer-readable data carrier. Features or advantages of the method can be transferred to the device or vice versa.

Some exemplary embodiments are now explained with reference to the figures.

### BRIEF DESCRIPTION OF THE DRAWINGS

FIG. 1 shows a vehicle in a schematic plan view with a projection device on board;

FIG. 2A is a partial perspective view of a passenger compartment, in the front of which the first and second visual representations can be realized, with a view from the interior displayed on the windscreen;

FIG. 2B is a partial view of a passenger compartment similar to that in FIG. 2A, but with a different orientation and/or arrangement of projection modules of the projection device;

FIG. 3A is a merely schematic circuit diagram of the functioning of the projection device according to a first exemplary embodiment;

FIG. 3B is a merely schematic diagram of the functioning of the projection device according to a second exemplary embodiment; and

FIG. 4 is a schematic flow chart of a method for generating and/or coordinating an overall visual representation on board a vehicle.

### DETAILED DESCRIPTION OF THE DRAWINGS

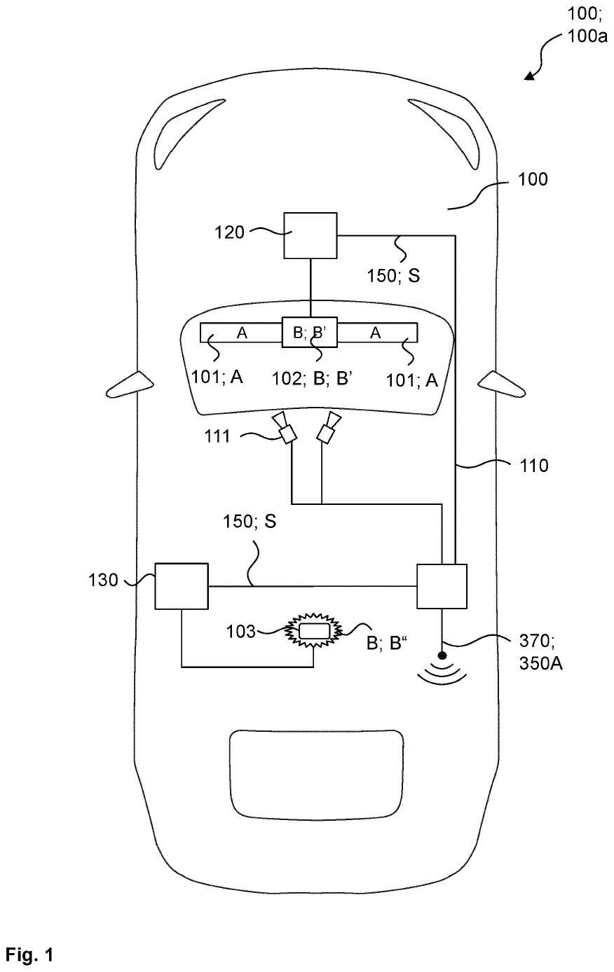

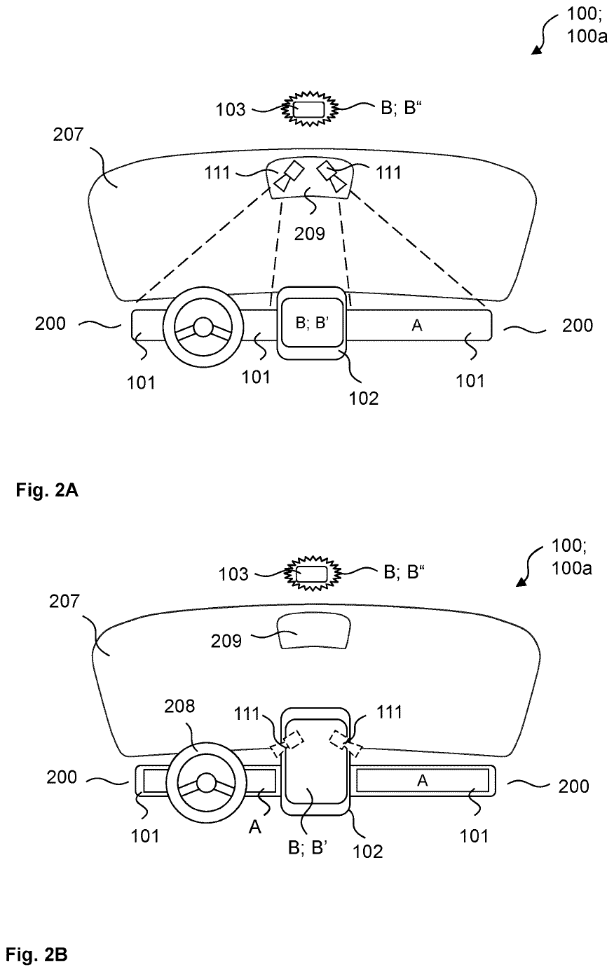

FIG. 1 shows a vehicle 100 in a schematic plan view, in particular a motor vehicle that has a projection device 110 on board, with which a first visual representation A can be generated in the passenger compartment 100a. The first visual representation A can be generated on board the vehicle 100, in particular by a projection, i.e. as a projected visual representation A. In principle, any surface 101 located in the passenger compartment 100a is suitable as the target surface that reproduces this projected visual representation A. However, a surface 101 of an instrument panel 200 (cf. FIGS. 2A and 2B), a center console underneath this (not shown) and/or another surface 101 of the front body, the passenger compartment 100a, the vehicle equipment thereof, and/or the interior trim thereof, is particularly suitable.

The surface 101 does not have to be suitable for the reproduction of projected and/or visual representations or representation content to the same extent as the reproduction surface or display surface of a display 102 or other display device, because the surface 101 in the vehicle should only be illuminated by the projection device 110 in such a way that in addition to its other technical, decorative or other function, this surface 101 can also have a certain visual effect as a target surface for a projection. This other surface 101 may nevertheless be advantageously monochromatic, color-neutral and/or provided in some areas with only slight curvatures and/or with a limited roughness, without this necessarily having to be requirements for the color or the geometric shape of this surface 101. For example, the surface 101 can still be well suited for projecting onto it intermittent still images, time-changing image motifs and/or videos, i.e. video data streams. For this purpose, it may be sufficient under certain circumstances if the contrast, resolution or other optical or visual properties of this surface 101 are less pronounced than in the case of an area of a vehicle display. Projected videos or images can be displayed on this surface 101, i.e. any light graphics, preferably three-color or multi-colored and/or composed of a large number of pixels.

FIG. 1 schematically indicates further reproduction devices 102, 103, which are also present on board the vehicle 100, which may be intended for the reproduction of other, further visual representations; for example, a display 102 on the display surface of which any video or other visual content can be displayed. In addition to navigation data or other technical, vehicle-related or trip-related or traffic-related information, videos for entertainment purposes may also properly be played back on the display 102.

Alternatively or additionally, an illumination device 103 can also be used on board the vehicle 100 to illuminate the interior 100a in a time-dependent manner; for example, by means of atmospheric, color-changing, rhythmic or otherwise variable illumination. The reproduction devices 120 and 130 with which the display 102 for video playback or the illumination device 103 for variable interior illumination can be used may be housed elsewhere in the vehicle than indicated in FIG. 1; the same applies to the projection device 110 for projecting other visual representations, such as the light graphics. All of the numerous types of visual representations mentioned, whether generated with the device 110, 120 or 130, can also be visual components of an audio-visual representation.

According to FIG. 1 at least one projection module 111 is provided for projecting a visual representation onto the surface 101 located in the passenger compartment 100a. As shown, two or more projection modules 111 can also be contained in the projection device 110 or arranged or installed with it in the vehicle 100 or the interior 100a thereof. As is schematically indicated in FIG. 1 in the plan view, such a projection module 111 can, for example, be arranged diagonally or decentrally behind the respective surface 101 in the direction of travel; for example, in or on a center console at a lower height or in the roof of the vehicle above the surface 101; for example, to project a first visual representation A onto a surface of the interior trim located below the windshield or windscreen; such as a video data stream or another image data stream that is preferably perceivable as varying with time.

According to this application, a projection device 110 is extended and improved in such a way that it can not only produce any specific visual representation A itself, but can also generate or at least coordinate a combined overall representation which combines two different, visually different representations A, B into a single combined overall representation. This overall representation includes both a first visual representation A projected by projection device 110 and another, second visual representation B. The latter is preferably not reproduced on the same surface 101, but elsewhere in the passenger compartment 100a. To create the other, second visual representation B, the projection device 110 may access one or more other reproduction devices 120, 130 which are also present in the vehicle and can instruct and/or coordinate these reproduction devices 120, 130 accordingly.

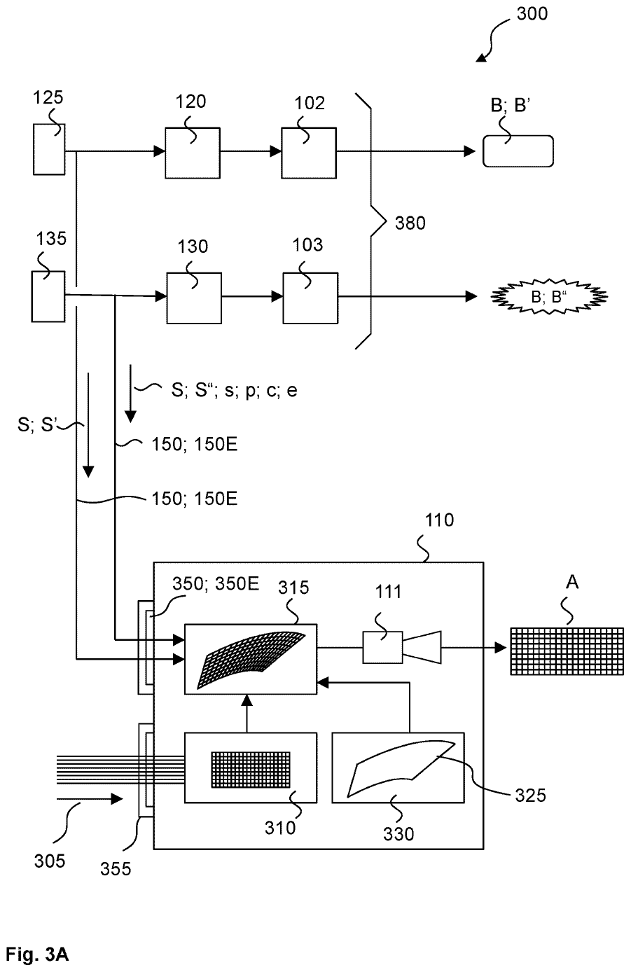

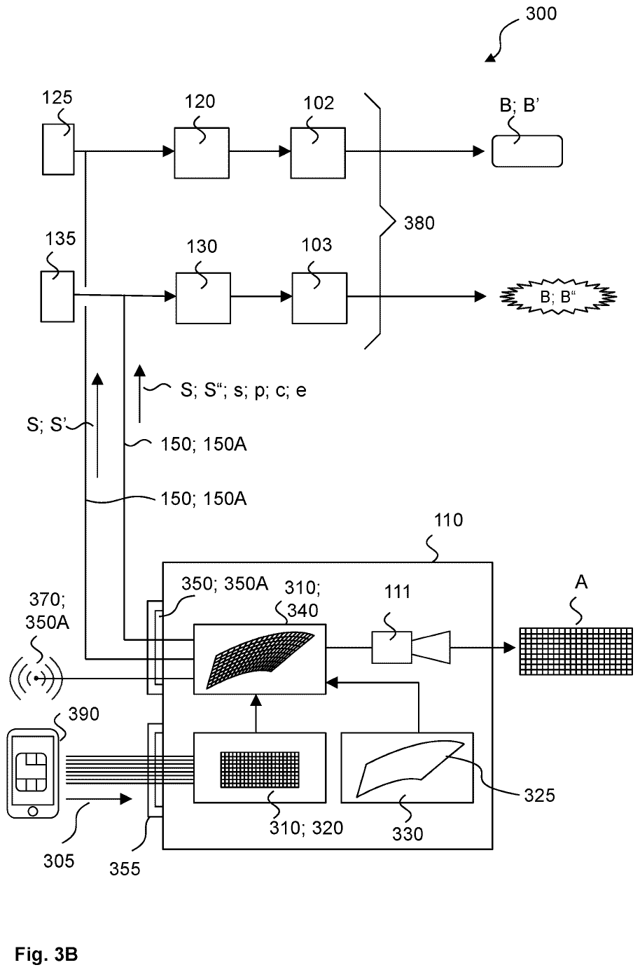

For the purposes of this coordination and/or interconnection, the projection device 110 may contain at least one coordination interface 350 (cf. FIGS. 3A and 3B) for coordination with other reproduction devices 120, 130, wherein FIG. 1 indicates schematically only the connecting lines 150 or other wireless connections 150 connected to the coordination interface 350. The connecting lines 150 or wireless connections 150 and the coordination interface 350 are discussed in more detail below with reference to FIG. 3A; 3B.

FIGS. 2A and 2B show two partial perspective views of the passenger compartment 100a according to two different exemplary embodiments with a view from the inside of the windscreen 207, in the front area of which various first and second visual representations A; B; B′; B″ can be realized. Below the windscreen 207 an instrument panel 200 is arranged which, as shown, can be divided into two areas for the driver and the front passenger, but can also be in one piece or continuous. As shown, the first visual effect or representation A can be projected onto the surface 101 on both sides of a display 102 by a suitable projection module 111—such as a DLP (Digital Light Processing) projector with a DMD chip (Digital Micromirror Device), a laser scanner or another image projector consisting of LEDs or laser diodes.

In addition, however, the projection device 110 is set up to generate this visual representation A as part of a new type of overall representation; for example coordinated and matched with illumination B; B′ presented in a time-varying manner, which is generated by an illumination device 103 or a reproduction device 130 for the illumination, and/or with a playback of a video B; B′ by a display 102 located in the vehicle as a further, second reproduction device 120. By coordinated playback or reproduction of multiple individual visual representations A and B (or B′ and/or B″), an overall representation can be generated consisting of two, three or even more different visual components, namely from those different individual components or individual representations that were not originally intended for a combined and/or specifically coordinated overall representation. Furthermore, by means of the projection device 110 proposed here, a number of reproduction devices 120, 130, which can be operated separately in the vehicle 100 but are not set up and/or controlled by the on-board electrical system to generate a combined and/or specifically coordinated overall representation, can be set up for this purpose later.

According to FIG. 2A, the projection module 111 is arranged on or in a rear view mirror, for example installed in it. Each projection module 111 is directed at the respective surface 101 onto which it is projecting. The respective projection module 111 may therefore be hardly recognizable to the vehicle occupant; except perhaps at the front lenses of the optical system of each projection module 111. The first visual representation A, projected by the projection module 111 or by both projection modules 111 together, which consists of a video, a sequence of still images, a temporal variation of one or more images or which may be some other visual effect, can be coordinated, i.e. jointly with and/or matched with another, second visual representation B′ and/or B″; in particular together with time-varying illumination of the interior 100a generated by an illumination device 103 and/or together with a video representation or other visual representation generated by a display 102 and/or the reproduction device 120 thereof. As a result, for example, in FIG. 2A, the instrument panel 200 is perceived practically over the entire width of the passenger compartment and, if appropriate, over another part of the time-varyingly illuminated passenger compartment 100a as a single visually reactive surface.

FIG. 2B shows a partial view of a passenger compartment 100a similar to that in FIG. 2A, but with a different orientation and/or arrangement of the projection modules 111 of the projection device 110. Instead of on the rear view mirror 209, the projection modules 111 are arranged and/or installed behind the display 102, for example in—or out of the driver's or passenger's line of sight—and oriented in such a way as to project the first visual representation A onto the surface 101 at an angle to this respective spaced apart and/or adjacent surface 101 of the instrument panel 200, to the surface of the centre console and/or obliquely to another surface in the interior 100a.

Alternatively, FIG. 2B can also be modified in such a way that the projection modules 111 are directed at two projection mirrors (not shown) that are arranged on, in or behind the rear view mirror 209. Instead of being projected directly onto the surface 101, the first visual representation A can also be projected onto this surface 101 via a plane or curved mirror.

The surface 101 used as the target surface for the projection may also be an ambient projection surface outside and/or near the vehicle display 102 instead of the surface of an instrument panel 200, an interior trim or other interior equipment.

For entertainment purposes, coordinated combination effects can thus be combined on board a vehicle; in particular with time-dependently varied illumination of sub-areas 101 in the passenger compartment, which for example are also designed as ambient illumination of certain contours or surfaces and/or can be implemented as background illumination or ambient illumination. This means that any surface 101 in the passenger compartment 100a can be used as ambient illumination or combination illumination, regardless of the surfaces for which an initial setup or pre-installation was intended for the vehicle or the on-board electrical system thereof.

FIG. 3A shows a merely schematic, exemplary circuit diagram for the operation of the projection device 110 according to a first exemplary embodiment. A system 300 is shown that uses the projection unit 110 proposed here and one or more reproduction devices 120, 130 for another, second visual representation B; B′; B′ on board a vehicle 100, which can be generated by means of the projection device 110 in a manner coordinated with the first visual representation A.

For this purpose, the projection device 110 and/or the projection module 111 contains a coordination interface 350, via which a coordination signal S relating to the first A and/or the second visual representation B; B′; B″; S′; S″ is passed between the projection device 110 and the vehicle 100. According to FIG. 3A, the coordination interface 350 is an input interface 350E, which receives at least one coordination signal S; S′; S″ intended for the projection device 110; in particular control commands s, p, c, e for starting, pausing, continuing and/or ending the visual representation A and/or the other, second visual representation B; B′; B″. The projection device 110 can receive these signals or control commands from the on-board electrical system 380.

In addition, the projection device 110 and/or the projection module 111 may contain an image data interface 355 via which video data and/or image data intended for the first visual representation A can be passed to and/or stored in the projection device 110 by avoiding and/or bypassing an on-board electrical system 380 installed in the vehicle 100. In particular, the image data interface 355 can be a separate interface 355 with higher bandwidth than the coordination interface 350; 350E and can be, for example, a wireless WLAN interface or an Ethernet interface. Alternatively, the image data interface 355 can also be integrated into the coordination interface 350. The generation of the first representation A can thus be carried out with the reception of information S; S′; S″ that refers to the playback or production of another, second representation B; B′; B″ and thus can be coordinated. For example, the projection module 110 is set up to coordinate the projection of the first visual representation A with the playback of a video B′ on a display 102 on board the vehicle 100 and/or with a time-varying illumination profile B′ of interior illumination in the vehicle 100 which serves as a second visual representation B.

Via the image data interface 355, the projection device 110 or the projection module 111 can be supplied with new, different or more up-to-date image material for the video data and/or image data of the first representation A at any time after the vehicle has been delivered; a replacement of the memory content of the projection device 110 via the image data interface 355 is therefore possible at any time to create newer, more up-to-date or more appealing representations than originally provided. Image data exchange via the image data interface 355 is possible at any time; even during the projection of a certain (first) representation.

The image data interface 355 in FIG. 3A may be connected to a user interface of the vehicle which is specifically intended for the subsequent exchange or updating of the image material for the projection device 110 or the projection module 111 thereof in order to be able to load additional light graphics, videos, images or other visual representations A at any time. Since, by the way, FIG. 3A shows the storage of the image data in the image data memory 310; 320 separately from the storage of the pre-distortion 325 in the pre-distortion memory 330 (see below), the image material of the same video or image data can be used simultaneously for projection on a driver's side, left side or surface 101 (for example of an instrument panel 200) and on a passenger's side, right-hand side or surface 101 (for example of an instrument panel 200), even if they are not mirror-symmetrical to each other.

For signal exchange of the signal S over the lines 150; 150E, a different bus system is preferably used; in particular, a LIN bus system and/or a bus system to which a control unit or control device for the internal or interior illumination of the vehicle is connected. For example, according to FIG. 3A, but also according to FIG. 3B, the projection device 110 and/or the projection module 111 thereof can contact a reproduction device 130 for the interior illumination 103; B″ and/or a control device 1135 intended for it, and this is either wired or wireless, as will be explained below. In this way, in particular a reproduction device 120; 130, a control unit or other unit designated for this purpose which is connected to the vehicle on-board electrical system 380 may be contacted, addressed, instructed and/or called upon by wire or wirelessly.

Furthermore, FIG. 3A illustrates an optional variant, which is only explained here as an example, with regard to a pre-distortion of video data and/or image data 305 for the first visual representation A. The projection module 111 is set up here to project image material of video data and/or image data 305 for the first visual representation A within an image field of the projection module 111 in a geometrically pre-distorted manner according to a defined pre-distortion 325. The defined pre-distortion 325 compensates in advance for distortion that occurs when projecting onto the surface 101 in the passenger compartment 100a
due to the arrangement of the projection module 111 decentrally, laterally, obliquely, tilted and/or otherwise relative to the surface 101 and/or the normal to the surface,
due to a curvature of the surface 101, and/or
due to projecting via a projection mirror.

The pre-distortion 325 defines a usable, pre-distorted image area within an available image area of the optical imaging system, which is stored in the pre-distortion memory 330 as memory content, such as a transformation matrix or a pre-distortion matrix. A variety of different pre-distortions 325 can be stored for different vehicle models or series, etc. Thus, for all available pre-distortions, one and the same pre-distortion memory 330 may be provided for the storage and/or retrieval of at least one specific pre-distortion 325, which correctly compensates the respective distortion occurring when projecting onto the surface 101 in the passenger compartment 100a in order to obtain an undistorted image or an undistorted first visual representation A on the surface 101.

In addition, an image data memory 310 may be provided in which the image material of the video data and/or image data for the first visual representation A are stored or can be stored interchangeably. As shown in FIG. 3A, the image data memory 310 can store the respective image data 305 unprocessed, i.e. without the defined pre-distortion 325. The projection module 111 can thus contain a separate pre-distortion unit 315, which only pre-distorts the image data, which was stored without pre-distortion, according to the defined pre-distortion 325 when the first visual representation A is projected.

The pre-distortion and storage of the image material in FIG. 3A can also be done differently than represented; in FIG. 3B, only the type of coordination of the first A and second representation B is significant, which the projection device 110 enables by means of the coordination interface 350, which in FIG. 3A is in the form of the input interface 350E and receives the coordination signals as input signals S; S′; S″ via the lines 150; 150E; there is a wired connection via these lines between the projection device 110 and the on-board electrical system 380 in the vehicle.

FIG. 3B shows a schematic circuit diagram of the operation of the projection device 110 according to a second exemplary embodiment, in which the coordination interface 350 contains an output interface 350A, which passes the control commands s, p, c, e generated by the projection device 110 for starting, pausing, resuming and/or stopping the other, second visual representation B; B′; B″.

Here, the projection device 110 itself sends the control or coordination signals S; S′; S″ to the respective reproduction device 120 and/or 130 in order to enable it to produce the combined and/or coordinated overall representation jointly and coordinated with the first visual representation.

In contrast to FIG. 3A, in FIG. 3B the signal direction of the connection 350 or 150 of the projection device 110 or the projection module 111 thereof is reversed, i.e. from an output port of the projection device 110 or the projection module 111 thereof to an input port of at least one reproduction device 120 and/or 130 or at least one connection of the on-board electrical system 380.

Although in FIGS. 3A and 3B the connections 150; 150E or 150; 150A are represented as wired connections or as cables, they can alternatively also be wireless connections; for example, via WLAN, radio, Ethernet or any other connection. This variation is conceivable for both FIG. 3A and FIG. 3B, irrespective of the direction of flow or direction of transmission of the coordination signals S between the projection device 110 or the projection module 111 thereof on the one hand and the on-board electrical system or other part of the vehicle on the other. FIG. 3B exemplifies this by the fact that, in addition to the output port 350A, a radio antenna or another transmitter unit 370 is ALSO drawn, which may be provided in addition to or instead of the output port 350A. Even the data traffic between the projection device 110 or the projection module 111 thereof and the on-board electrical system 380 or any other part of the vehicle, which is only used for the coordination of the first and second visual representations A, B, can also be wireless instead of wired. For this purpose, the on-board electrical system may be connected to a suitable receiver unit, such as a receiving antenna (not shown). This means that the temporal coordination with a reproduction unit of the vehicle is also possible wirelessly instead of wired.

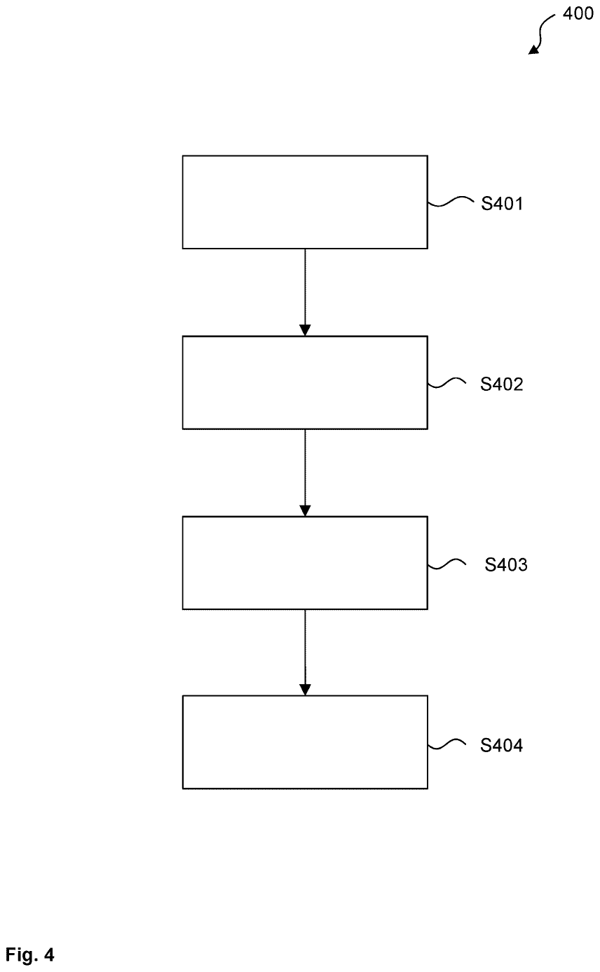

Further variations, which are contemplated in FIG. 3B, but also in FIG. 4A, are explained below using FIG. 3B as an example. Any combination of these variations with each other, any combination of these variations with the above wireless variation and/or any combination of these variations as a whole with any exemplary embodiments of this application is conceivable.

First, FIG. 3B (and alternatively FIG. 3A) can be modified in such a way that the exchange or storage of image data 305 for the first visual representation A is carried out via a wired image data interface 355 instead of a wireless image data interface 355, for example an antenna or other receiver unit 355 for the wireless reception of new image material for the corresponding video data and/or image data. Thus, the image data interface 355 can also be wireless, i.e. both interfaces, both the coordination interface 350 (regardless of whether the 350E for incoming coordination signals S or the 350A for outgoing coordination signals S) and the image data interface 355 can be in the form of wireless interfaces.

Secondly, the image data interface 355 may be set up for the data exchange of image data or image material with a user's own electronic device, in particular a smartphone 390, rather than for the data exchange of image data or image material with an interface (wired or wireless) of the vehicle, the on-board electrical system or any other system on board the vehicle. This means that data traffic for the renewal or loading or storage of other, newer and/or more up-to-date video and/or image representations A can also be carried out with a smartphone 390 or other user-owned device instead of with the vehicle. This second variation is even preferable, although a vehicle, for example by means of a built-in or electronic SIM card, can perform the same functions as an external smartphone 390 or any other user device; in particular can run the same apps or software programs. However, if a smartphone 390 or other user-owned, external electronic device is depicted or mentioned in the figures or in the application, an alternative equivalent device can be used or controlled, queried, instructed and/or read as an internal component of the vehicle for communication, in particular for coordination or cooperation.

If the data exchange in the case of a transfer of new image material for the first representation A (for example for new or different light graphics) is carried out with a smartphone 390 or other user device or with an app installed on it, it may be provided, for example, that the projection device 11O and/or the projection module 111 is coupled to the smartphone or user device 390—preferably wirelessly—and can be used there as an additional image screen.

Thirdly, those units which are shown in FIG. 3A and/or FIG. 3B as part of the projection device 110 but not belonging to the actual projection module 111 can alternatively be included in the projection module 111 itself. This applies in particular to the coordination interface 350; 350A; 350B and/or to the image data interface 355. Thus, in contrast to FIG. 3A and/or FIG. 3B, these interfaces 350; 355, but alternatively or additionally the units 310, 315, 320, 330, 340 or some of them may be included in the projection module 111 instead of being outside it.

Fourthly, any variants in terms of the way in which the video data and/or image data are stored and/or pre-distorted may be combined with any exemplary embodiment described in or derivable from this application.

As an exemplary variation of this, FIG. 3B shows that instead of only one image data memory 310 from FIG. 3A, two separate image data memories are now provided, namely a first image data memory 320 and a second image data memory 340. Here, light graphics, visual effects or other (first) visual representations—more precisely the video data and/or image data or the image material for them—to be loaded are initially stored in the first image data memory 320 without prior application of the pre-distortion 325. Then or later, they can be pre-distorted by applying the pre-distortion 325 stored in the pre-distortion memory 330 —for example a transformation matrix—and are stored pre-distorted in the second image data memory 340, where they only have to be retrieved when projecting, so that when projecting no computational effort is required for pre-distortion. Furthermore, the first image data memory 320 could alternatively be omitted compared to FIG. 3B, and image material to be loaded for the first visual representation A is then immediately pre-distorted during downloading or storing and is stored in the image data memory 340; 310. Furthermore, alternatively, this image data memory 340; 310 can also be omitted, so that the image material for the first visual representations A is pre-distorted and projected immediately after reception by the projection device 110 and/or the projection module 111.

Whenever the application mentions communication, in particular coordination between the projection device 110 or the projection module 111 and the vehicle 100, in particular communication or coordination with a reproduction device 120; 130, this may involve communication or coordination with a control unit 125; 135 intended for the reproduction device 120; 130. Instead with of the reproduction device 120; 130, communication or coordination can therefore be carried out with such a control unit 125; 135 itself.

Finally, a respective reproduction device 120; 130 and/or a respective control unit 125; 135 intended for it may contain a user interface (not specifically shown). Such a control unit and/or user interface may be connected upstream of the respective reproduction device 120; 130.

The system 300 on board the vehicle 100 can, moreover, on the one hand contain an on-board electrical system 380 and/or the reproduction devices 120; 130 connected to it—if appropriate including control units intended for this purpose—and on the other hand may include the projection device 110 and/or the projection module 111.

FIG. 4 shows a schematic flow chart of a method 400. The method 400 is used to generate and/or coordinate an overall visual representation on board a vehicle 100 and includes the following steps:
Provision 401 of a vehicle 100 in the passenger compartment 100a of which at least one visual representation can be reproduced,
Setting up S402 a projection device 110, containing a projection module 111, with which a first visual representation A can be generated by projecting onto a surface 101 in a passenger compartment 100a, on board the vehicle 100,
Passing S403 a coordination signal S; S′; S″ relating to a first visual representation A and/or a second visual representation B; B′; B′; between the projection device 110 and the vehicle 100 via a coordination interface 350, and
Generating and/or coordinating S404 a combined overall representation, in which a first visual representation A is projected by the projection device 110 onto the surface 101 in the passenger compartment 100a and elsewhere in the passenger compartment 100a a different, second visual representation B; B′; B″ is reproduced by means of the projection device 110 using the coordination signal S; S′; S″.

### REFERENCE SIGNS

100 Vehicle
100a Passenger compartment
101 Surface
102 Display
103 Illumination device
110 Projection device
111 Projection Module
120 Reproduction device (display)
125 Control unit (display)
130 Reproduction device (illumination)
135 Control unit (illumination)
150 Signal line
150A Output line
150E Input line
200 Instrument panel
207 Windscreen
208 Steering wheel
209 Rear view mirror
300 System
305 Image data
310 Image data memory
315 Pre-distortion unit
320 First image data memory
325 Pre-distortion
330 Pre-distortion memory
340 Second image data memory
350 Coordination interface
350A Output Interface
350E Input Interface
355 Image data interface
370 Transmitting unit
380 Onboard electrical system
390 Smartphone
400 Method
S401-S404 Step of the method
A First visual representation
B; B′; B″ Second visual representation
S; S′; S″ Coordination signal
s, c, e, p Control command

1.-11. (canceled)

12. A projection device on board a vehicle, comprising:
a projection module with which a first visual representation is generated by projecting onto a surface in a passenger compartment,
wherein the projection device is configured to produce and/or coordinate a combined overall representation in which:
the first visual representation is projected onto the surface in the passenger compartment, and
a different, second visual representation is reproduced elsewhere in the passenger compartment,
wherein the projection device and/or the projection module comprises a coordination interface via which a coordination signal relating to the first and/or the second visual representation is transmitted between the projection device and the vehicle.

13. The projection device according to claim 12, wherein
the coordination interface comprises an output interface which forwards control commands generated by the projection device for starting, pausing, resuming and/or stopping the different, second visual representation.

14. The projection device according to claim 13, wherein
the coordination interface comprises an input interface which receives control commands intended for the projection device for starting, pausing, resuming and/or stopping the first visual representation.

15. The projection device according to claim 12, wherein
the projection device, the projection module and/or the coordination interface contains an image data interface, via which video data and/or image data intended for the first visual representation is transmittable to and/or storable in the projection device while avoiding and/or bypassing an on-board electrical system configured in the vehicle.

16. The projection device according to claim 12, wherein the projection module coordinates the projection of the first visual representation carried out on board the vehicle as the second visual representation with:
playback of a video on a display, and/or
a temporal variation of interior lighting of the vehicle.

17. The projection device according to claim 12, wherein
the projection module is configured to project video data and/or image data for the first visual representation within an image field of the projection module geometrically pre-distorted according to a defined pre-distortion, wherein the defined pre-distortion compensates in advance for a distortion that occurs when projecting onto the surface in the passenger compartment:
(i) due to an arrangement of the projection module decentrally, laterally, obliquely, tilted and/or otherwise relative to the surface and/or a normal to the surface,
(ii) due to a curvature of the surface, and/or
(iii) due to projecting via a projection mirror.

18. The projection device according to claim 12, wherein the projection module is installed in an instrument panel or other front structure of the passenger compartment of the vehicle:
(i) on a rear view mirror in the passenger compartment, and/or
(ii) on or behind a vehicle display intended for video playback, and from there is directed to the surface directly or via a projection mirror.

19. The projection device according to claim 12, wherein the projection module projects the first visual representation projected:
(i) onto the surface of an instrument panel,
(ii) onto the surface of interior trim,
(iii) onto any other surrounding projection surface outside of and/or near to a display, and/or
(iv) onto the surface of any other equipment of the passenger compartment, and coordinates it with a video played back on a display and/or time-dependently varied interior lighting.

20. The projection device according to claim 12, wherein
the projection module projects the first visual representation onto the surface of a vehicle seat, a backrest, a headrest, an instrument panel, an interior trim and/or any other equipment of the passenger compartment, and coordinates it with time-dependently varied interior lighting.

21. A vehicle comprising a projection device according to claim 12.

22. A method for generating and/or coordinating an overall visual representation on board a vehicle, the method comprising the steps of:
providing a vehicle, in a passenger compartment of which at least one visual representation is reproducible;
setting up a projection device, containing a projection module with which a first visual representation is generated by projecting onto a surface in the passenger compartment on board the vehicle;
transmitting a coordination signal relating to the first visual representation and/or a second visual representation between the projection device and the vehicle via a coordination interface; and
generating and/or coordinating a combined overall representation in which the first visual representation is projected by the projection device onto the surface in the passenger compartment and, elsewhere in the passenger compartment, a different, second visual representation is reproduced via the projection device using the coordination signal.
